(19) United States
(12) Patent Application Publication
(10) Pub. No.: US 2018/0241341 A1
(43) Pub. Date: Aug. 23, 2018

(54) METHODS AND SYSTEMS FOR MOUNTING SOLAR MODULES

(71) Applicants: Christopher NEEDHAM, Culpeper, VA (US); SUNEDISON, INC., Maryland Heights, MO (US)

(72) Inventors: Christopher Thomas Needham, Culpeper, VA (US); Bharat Malapareddy, Bangalore Karnataka (IN); Anurag Mapati, Bangalore Karnataka (IN); Manickam Narayanan, Chennai TN (IN); Rajesh Manapat, Bangalore, Karnataka (IN); Nagendra Srinivas Cherukupalli, Cupertino, CA (US)

(21) Appl. No.: 15/509,939

(22) PCT Filed: Sep. 9, 2015
(86) PCT No.: PCT/US2015/049083

§ 371 Date: Jul. 25, 2017

Related U.S. Application Data
(60) Provisional application No. 62/047,965, filed on Sep. 9, 2014.

(51) Int. Cl. H02S 20/23; H02S 20/24; F24S 25/12; F24S 25/20; F24S 25/60; F24S 25/61; F24S 25/615

(52) U.S. Cl. CPC H02S 20/23; H02S 20/24; F24S 25/12; F24S 2025/601; F24S 25/60; F24S 25/61; F24S 25/615; F24S 25/20

(57) ABSTRACT

A solar assembly (200) includes a solar module (100) including a solar laminate (102) mounted within a frame (104) that circumscribes the solar laminate. The solar assembly also includes a mount (202) supporting the solar module including a first end and an opposing second end, wherein the first end is attached to the solar module. The solar assembly further includes a structural adhesive compound (210) and a mounting surface (230). The structural adhesive compound is positioned between the mount second end and the mounting surface to facilitate bonding the mount to the mounting surface.

### CROSS-REFERENCE TO RELATED APPLICATION

This application claims priority to U.S. Provisional Patent Application No. 62/047,965 filed on Sep. 9, 2014, the entire disclosure of which is hereby incorporated by reference in its entirety.

### FIELD

This disclosure generally relates to mounting systems for solar modules and, more specifically, to methods for mounting solar modules to a mounting surface using an adhesive.

### BACKGROUND

Solar modules are devices which convert solar energy into other forms of useful energy (e.g., electricity or thermal energy). Such modules are typically positioned above an underlying support surface by a rack. This rack may be configured to position the solar module at an angle relative to the support surface to minimize an angle of incidence between the solar module and the sun's rays. Minimizing this angle of incidence increases the amount of solar energy gathered by the solar module.

When the underlying surface is the roof of a structure, the racks must comply with wind loading requirements that are meant to prevent racks from being blown from the roof. At least some known roof mounted racks include metal brackets that are fastened to the roof using a mechanical anchor. The anchors penetrate through the bracket and the roof to attach to the support joists of the structure. Such mounting systems typically require numerous penetrations of the roof to securely connect the solar module to the structure's support joists. Each roof penetration creates a potential inlet for water that may damage the structure. Furthermore, penetrating the roof with numerous fasteners may threaten the structural integrity of the roof and the building. Also, the time and number of mechanical fasteners required to securely mount the solar modules may be expensive.

Another method of connecting solar modules to rooftops is to add heavy ballasts to weigh down the solar modules. The ballast is typically formed from a heavy concrete. This additional ballast on the roof acts as a constant dead load on the concrete slab and support beams. Improper placement of the ballast or exceeding the dead load limit of the roof could damage the concrete slab. Also, roofs have a predetermined live load limit, and adding additional ballast constrains the use of the roof for other purposes.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a solar assembly is provided. The solar assembly includes a solar module including a solar laminate mounted within a frame that circumscribes the solar laminate. The solar assembly also includes a mount supporting the solar module including a first end and an opposing second end. The first end is attached to the solar module, and the second end is attached to a mounting surface using a structural adhesive compound.

In another aspect, a solar system is provided. The solar system includes a solar module including a solar laminate mounted within a frame that circumscribes the solar laminate. The solar system also includes a mount supporting the solar module including a first end and an opposing second end, wherein the first end is attached to the solar module. The solar system further includes a structural adhesive compound and a mounting surface. The structural adhesive compound is positioned between the mount second end and the mounting surface to facilitate bonding the mount to the mounting surface.

In yet another aspect, a method of assembling a solar assembly is provided. The method includes providing a solar module and attaching a first end of a mount to the solar module. The method also includes applying a structural adhesive compound to at least one of a second end of the mount and a mounting surface. The mount is then bonded to the mounting surface using the structural adhesive compound.

Various refinements exist of the features noted in relation to the above-mentioned aspects. Further features may also be incorporated in the above-mentioned aspects as well. These refinements and additional features may exist individually or in any combination.

For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example solar module;

FIG. 2 is a cross-sectional view of the solar module shown in FIG. 1 taken along the line A-A;

FIG. 3 is a mounting system for use with the solar module shown in FIG. 1;

FIG. 4 is a side view of an solar assembly for use with the mounting system shown in FIG. 3;

FIG. 5 is perspective view of a mounting bracket for use with the solar assembly shown in FIG. 4;

FIG. 6 is perspective view of an alternative solar assembly for use with the solar module shown in FIG. 1; and

FIG. 7 is an enlarged view of a mounting block for use with the solar assembly shown in FIG. 6.

Like reference symbols in the various drawings indicate like elements.

### DETAILED DESCRIPTION

This disclosure generally relates to mounting systems for solar modules and, more specifically, to methods for mounting solar modules to a mounting surface using an adhesive.

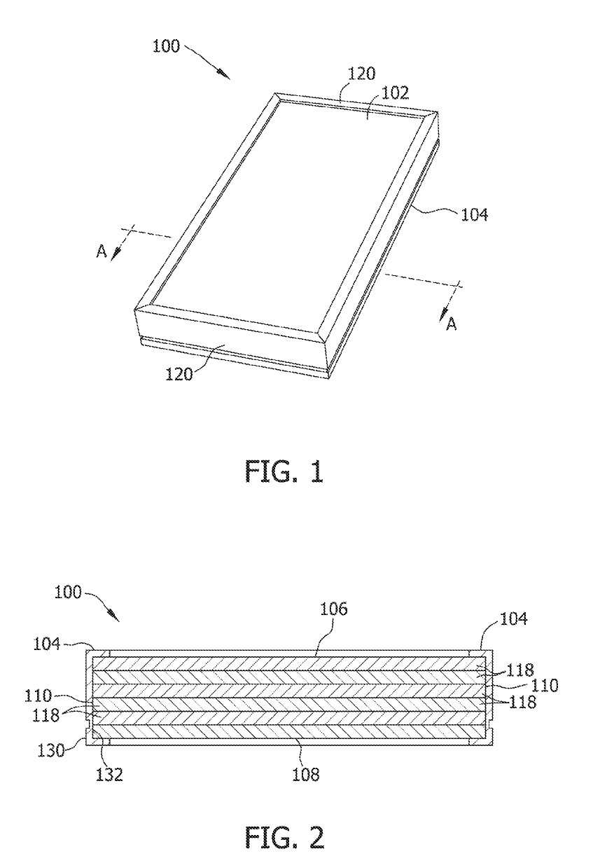

Referring initially to FIGS. 1 and 2, a solar module of one embodiment is indicated generally at 100. A perspective view of solar module 100 is shown in FIG. 1. FIG. 2 is a cross-sectional view of solar module 100 taken at line A-A as shown in FIG. 1. Solar module 100 includes a solar laminate 102 and a frame 104 circumscribing solar laminate 102.

Solar laminate 102 includes a top surface 106 and a bottom surface 108 (shown in FIG. 2). Edges 110 extend between top surface 106 and bottom surface 108. In this embodiment, solar laminate 102 is rectangular shaped. In other embodiments, solar laminate 102 may have any suitable shape.

As shown in FIG. 2, the solar laminate 102 has a laminate structure that includes several layers 118. Layers 118 may include, for example, glass layers, non-reflective layers, electrical connection layers, n-type silicon layers, p-type silicon layers, and/or backing layers. One or more layers 118 may also include solar cells (not shown). In other embodiments, solar laminate 102 may have more or fewer, including one, layers 118, may have different layers 118, and/or may have different types of layers 118.

As shown in FIG. 1, frame 104 circumscribes solar laminate 102. Frame 104 is coupled to solar laminate 102, as best shown in FIG. 2. Frame 104 assists in protecting edges 110 of solar laminate 102. Example frame 104 includes an outer surface 130 spaced apart from solar laminate 102 and an inner surface 132 adjacent solar laminate 102. Outer surface 130 is spaced apart from and substantially parallel to inner surface 132. In the example embodiment, frame 104 is made of aluminum. More particularly, in some embodiments frame 104 is made of 6000 series anodized aluminum. In other embodiments, frame 104 may be made of any other suitable material providing sufficient rigidity including, for example, rolled or stamped stainless steel, plastic, or carbon fiber.

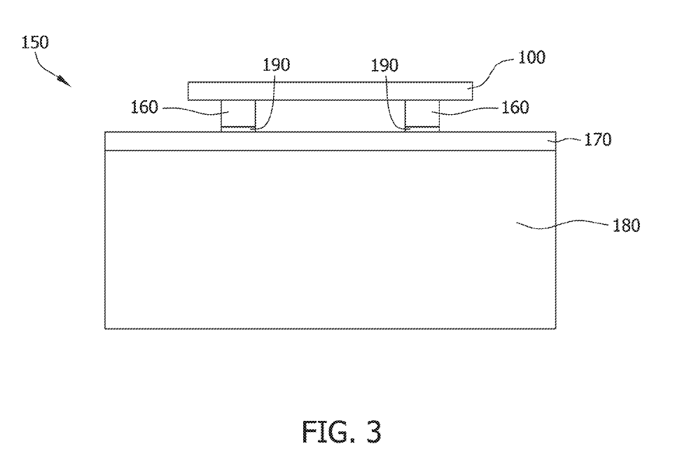

FIG. 3 is a schematic diagram of a solar system 150 that includes a solar module 100, a plurality of mounting structures 160, such as a bracket and/or a block, configured to support solar module 100. Each mounting structure 160 is attached to a roof 170 of a building 180 using at least one layer of structural adhesive compound 190. Furthermore, each mounting structure 160 is attached to solar module 100. Although only a single solar module 100 is shown in FIG. 3, solar system 150 may include a plurality of solar modules 100 attached to roof 170 via mounting structures 160. Moreover, although only two mounting structures 160 are shown, solar system 150 may include more or fewer mounting structures 160. Additionally, each mounting structure 160 may or may not be the same as every other mounting structure 160.

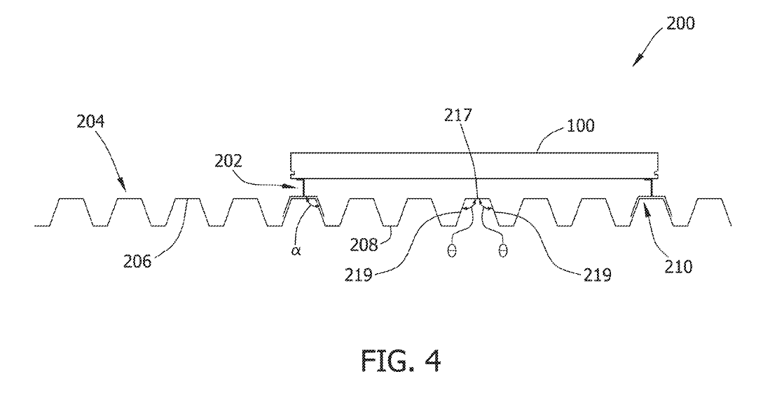

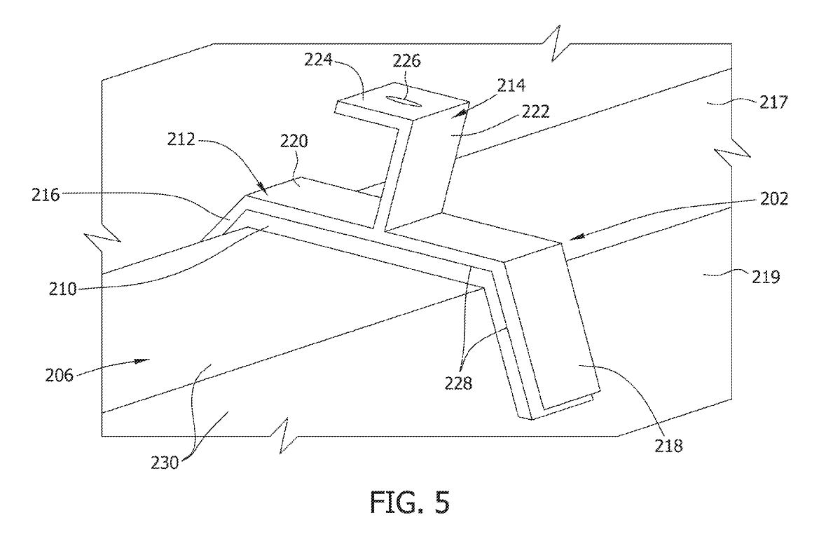

Referring now to FIGS. 4 and 5, a solar assembly is indicated generally at 200. FIG. 4 is a side view of solar assembly 200, and FIG. 5 is a perspective view of a mounting bracket 202 that may be used with solar assembly 200.

Solar assembly 200 includes solar module 100 coupled to a plurality of mounting brackets 202, which are coupled to a roof 204 of a building (not shown). In the example embodiment, roof 204 is a corrugated metal roof having a plurality of ridges 206 that define a valley 208 between adjacent ridges 206. Mounting brackets 202 are configured to straddle a ridge 206 when positioned on roof 204. Solar assembly 200 also includes a structural adhesive compound 210 for bonding each mounting bracket 202 with a respective ridge 206 of roof 204.

Mounting bracket 202 includes a base portion 212 and an extension portion 214, as shown in FIG. 5. Base portion 212 includes a first segment 216 and a second segment 218 spaced apart from first segment 216 by a third segment 220. In the example embodiment, first and second segments 216 and 218 extend downward from opposing ends of third segment 220 such that base portion 212 is generally U-shaped. Furthermore, the distal ends of first and second segments 216 and 218 taper away from each other such that an obtuse angle α (shown in FIG. 4) is formed between first segment 216 and third segment 220 and between second segment 218 and third segment 220. As such, base portion 212 has a shape that substantially corresponds to a shape of ridge 206 to which it is coupled. More specifically, angle α between third segment 220 and each of segments 216 and 218 is approximately equal to an angle θ (shown in FIG. 4) defined between a top wall 217 and each side wall 219 of ridge 206. In other embodiments, first segment 216 and second segment 218 may be oriented in any configuration that enables mounting bracket 202 to function as described herein.

Extension portion 214 includes an extension segment 222 extending orthogonally from third segment 220 and a coupling flange 224 that extends orthogonally from a distal end of extension segment 222 such that coupling flange 224 is oriented parallel to third segment 220. Coupling flange 224 includes an opening 226 defined therein configured to receive a fastener (not shown) to couple mounting bracket 202 to solar module 100. In other embodiments, extension segment 222 and coupling flange 224 may be oriented in any configuration that enables mounting bracket 202 to function as described herein.

Base portion 212 and extension portion 214 may be constructed of any suitable material for the purposes described herein. In the example embodiment, base portion 212 and extension portion 214 are made of aluminum. In other embodiments, base portion 212 and extension portion 214 may be made of any suitable material including, for example, other metals, plastics, fiberglass, or any combination thereof.

In the example embodiment, base portion 212 and extension portion 214 are integrally formed as one piece. More particularly, base portion 212 and extension portion 214 are die cast. In other embodiments, base portion 212 and extension portion 214 may be formed by any other suitable process including, for example, stamping, machining, and 3D printing. Further, in some embodiments, base portion 212 and extension portion 214 may be formed separately and joined together to form mounting bracket 202, such as by welding.

Base portion 212 includes a bottom surface 228 positioned proximate a top surface 230 of ridge 206. In the example embodiment, structural adhesive compound 210 is applied to at least one of surfaces 228 and 230 to couple mounting bracket 202 to roof 204 such that surfaces 228 and 230 do not contact each other. Alternatively, in some embodiments, portions of surfaces 228 and 230 may contact each other. In the example embodiment, structural adhesive compound 210 is a substantially liquid adhesive such as, but not limited to, a polyurethane or polyether. Alternatively, structural adhesive compound 210 may be any adhesive that facilitates coupling mounting bracket 202 to roof 204. When applied, structural adhesive compound 210 reacts with moisture in the air to form a high molecular weight cross link polymer that requires approximately 24 hours to cure to approximately 50% of the maximum tensile strength of the structural adhesive compound 210 to allow for rapid installation. Alternatively, structural adhesive compound 210 may require any amount of time to cure to any tensile strength. After curing, structural adhesive compound 210 includes a minimum tensile strength of 100 pounds per square inch. Structural adhesive compound 210 includes elastic characteristics that allow a small amount of bracket movement that permits displacements of solar module 100 due to wind. As such, structural adhesive compound 210 reduces the shear stress and fatigue loading resulting from wind.

In an example embodiment, structural adhesive compound 210 includes a thickness in a range of between approximately 2 millimeters (mm) to approximately 10 mm. Alternatively, structural adhesive compound 210 may have any thickness that facilitates operation of solar assembly 200 as described herein. Generally, the thickness of structural adhesive compound 210 is based on the materials to be bonded together.

Furthermore, structural adhesive compound 210 is removable such that solar module 100 and mounting brackets 202 may be removed from roof 204 and repositioned at a different location either also on roof 204 or at a different facility. More specifically, the adhesion bond between mounting bracket 202 and roof 204 may be broken by passing a metal wire between base portion bottom surface 228 and ridge top surface 230. Alternatively, mounting bracket 202 may be removable by any means that facilitates operation of solar assembly 200 as described herein.

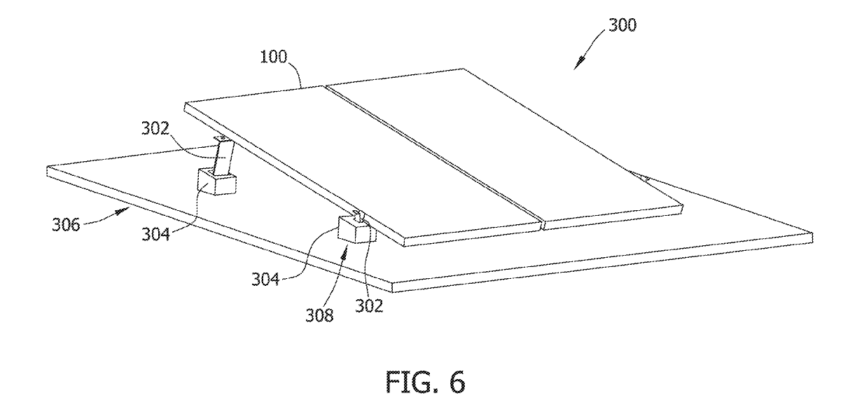

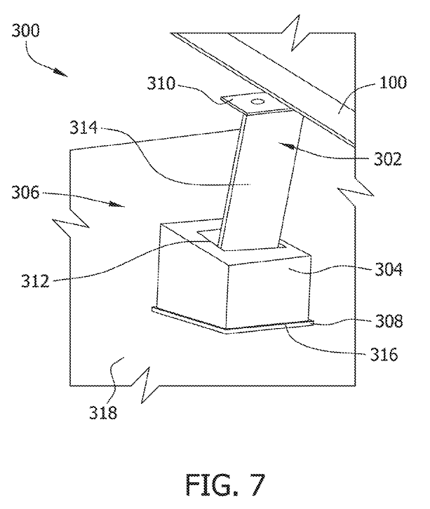

Referring now to FIGS. 6 and 7, a solar assembly is indicated generally at 300. FIG. 5 is a perspective view of solar assembly 300, and FIG. 6 is an enlarged perspective view of a portion of solar assembly 300. Solar assembly 300 includes solar module 100, a plurality of mounting brackets 302, and a plurality of mounting blocks 304 coupled in sequence to a roof 306 of a building, such as building 180 (shown in FIG. 3). In the example embodiment, roof 306 is a substantially flat concrete roof. A structural adhesive compound 308 bonds each mounting block 304 to roof 306.

As shown in FIG. 7, each mounting bracket 302 includes a module flange 310 and a block flange 312 spaced apart from module flange 310 by a body portion 314. Module and block flanges 310 and 312 extend from opposing ends of body portion 314 such that mounting bracket 302 is substantially U-shaped. Module flange 310 is configured to couple to solar module 100 using at least one fastener (not shown). Similarly, block flange 312 is configured to couple to mounting block 304 using at least one fastener (not shown). Alternatively, mounting bracket 302 may be coupled to mounting block 304 or formed integrally therewith in any manner that enables operation of solar assembly 300 as described herein. In other embodiments, module and block flanges 310 and 312 may be oriented in any configuration that enables mounting bracket 302 to couple solar module 100 to mounting block 304 as described herein. Moreover, as shown in FIG. 6, solar assembly 300 may include mounting brackets 302 and mounting blocks 304 that are different from other mounting brackets 302 and mounting blocks 304 in solar assembly 300 in size and/or shape.

Mounting bracket 302 may be constructed of any suitable material for the purposes described herein. In the example embodiment, mounting brackets 302 are made of aluminum. In other embodiments, mounting brackets 302 may be made of any suitable material including, for example, other metals, plastics, fiberglass, composite materials, or any combination thereof. In the example embodiment, each mounting bracket 302 is integrally formed as one piece. More particularly, each mounting bracket 302 is die cast. In other embodiments, each mounting bracket 302 may be formed by any other suitable process including, for example, stamping, machining, and 3D printing.

Mounting block 304 serves as a base of solar assembly 300 and is configured to be coupled between roof 306 and mounting bracket 302. Each mounting block 304 includes a bottom surface 316 positioned proximate a top surface 318 of roof 306. In the example embodiment, structural adhesive compound 308 is applied to at least one of surfaces 316 and 318 to couple mounting block 304 to roof 306 such that surfaces 316 and 318 do not contact each other. Alternatively, in some embodiments, portions of surfaces 316 and 318 may contact each other. In the example embodiment, structural adhesive compound 308 is a substantially liquid adhesive such as, but not limited to, polyurethane or polyether. Alternatively, structural adhesive compound 308 may be any adhesive that facilitates coupling mounting block 304 to roof 306. When applied, structural adhesive compound 308 reacts with moisture in the air to form a high molecular weight cross link polymer that requires approximately 24 hours to cure to approximately 50% of the maximum tensile strength of the structural adhesive compound 308 to allow for rapid installation. Alternatively, structural adhesive compound 308 may require any amount of time to cure to any tensile strength. After curing, structural adhesive compound 308 includes a minimum tensile strength of 100 pounds per square inch. Structural adhesive compound 308 also includes elastic characteristics that enable some displacement of solar module 100 due to wind. As such, structural adhesive compound 308 reduces the shear stress and fatigue loading resulting from wind.

In an example embodiment, structural adhesive compound 308 includes a thickness in a range of between approximately 2 millimeters (mm) to approximately 10 mm. Alternatively, structural adhesive compound 308 may have any thickness that facilitates operation of solar assembly 300 as described herein. Generally, the thickness of structural adhesive compound 308 is based on the materials to be bonded together.

Furthermore, structural adhesive compound 308 is removable such that solar module 100 and mounting blocks 304 may be removed from roof 306 and repositioned at a different location either also on roof 306 or at a different facility. More specifically, the adhesion bond between mounting blocks 304 and roof 306 may be broken by passing a metal wire between block bottom surface 316 and roof top surface 318. Alternatively, mounting block 304 may be removable from roof 306 by any means that facilitates operation of solar assembly 300 as described herein.

Because of the adhesion bond between mounting blocks 304 and roof 306, solar assembly 300 avoids inclusion of a heavy ballast used in known mounting systems to weigh down the solar module to prevent movement due to wind. Moreover, in some embodiments, the adhesion bond is sufficient to hold solar assembly 300 to roof 306 without the use of any weighted ballast at all. In the example embodiment, each mounting block 304 is formed from steel or a lightweight concrete material. In other embodiments, mounting blocks 304 are formed from any material that enables solar assembly 300 to operate as described herein. Each mounting block 304 is formed from a material such that the weight of mounting block 304 is within a range of between approximately 1% to approximately 50% the weight of a known concrete ballast block. More specifically, each mounting block 304 is formed from a material such that the weight of mounting block 304 is within a range of between approximately 10% to approximately 40% the weight of a known concrete ballast block. Use of a relatively lightweight mounting block 304 reduces the weight load on roof 306.

Embodiments of the methods and systems described herein achieve superior results compared to prior methods and systems. For example, the mounting assemblies described herein simplify the installation of solar modules onto the roof of a structure. More specifically, the embodiments described herein use an adhesive to bond a mounting structure to a roof. As such, the mounting assemblies described herein eliminate the need to penetrate a roof with fasteners, and, therefore, do not damage roofs during installation or affect the structural integrity of the roof. The embodiments and methods described above use lightweight mounting structures that either reduce the ballast weight on the roof or eliminate the need for a ballast altogether. As such, time and cost expended calculating proper placement and load limits are saved.

Embodiments of the assemblies may also reduce assembly labor, time, and, therefore, cost of installing the system. The assemblies may also be cheaper due to the elimination of numerous fasteners needed at an installation site. Furthermore, the above-described mounting assemblies enable simple removal of solar modules for installation at a different location. Moreover, the adhesives used in the above-described embodiments have a predetermined modulus of elasticity that enables the adhesive to stretch to account for small displacements of the solar module due to wind. Generally, solar modules installed using embodiments of the mounting brackets may be easier, faster, less expensive, and/or safer to install than solar modules utilizing prior systems.

When introducing elements of the present invention or the embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A solar assembly comprising:
a solar module comprising a solar laminate mounted within a frame that circumscribes the solar laminate;
a mount supporting the solar module comprising a first end and an opposing second end, wherein the first end is attached to the solar module, and wherein the second end is attached to a mounting surface using a structural adhesive compound.

2. A solar assembly in accordance with claim 1, wherein the mount comprises a mounting bracket.

3. A solar assembly in accordance with claim 2, wherein the mount comprises a mounting block coupled between the mounting bracket and the mounting surface.

4. A solar assembly in accordance with claim 3, wherein the mounting block is formed from one of steel or lightweight concrete.

5. A solar assembly in accordance with claim 2, wherein the mounting bracket comprises a base portion coupled to the mounting surface and an extension portion coupled to the solar module.

6. A solar assembly in accordance with claim 5, wherein a shape of the base portion substantially corresponds to a shape of the mounting surface.

7. A solar assembly in accordance with claim 6, wherein the base portion is generally U-shaped.

8. A solar assembly in accordance with claim 1, wherein the structural adhesive compound comprises at least one of a polyurethane and a polyether material.

9. A solar system comprising;
a solar module comprising a solar laminate mounted within a frame that circumscribes the solar laminate;
a mount supporting the solar module comprising a first end and an opposing second end, wherein the first end is attached to the solar module;
an structural adhesive compound;
a mounting surface, wherein the structural adhesive compound is positioned between the mount second end and the mounting surface to facilitate bonding the mount to the mounting surface.

10. A solar system in accordance with claim 9, wherein the structural adhesive compound comprises at least one of a polyurethane and a polyether material.

11. A solar system in accordance with claim 9, wherein the structural adhesive compound comprises a predetermined modulus of elasticity to facilitate displacement of the solar module.

12. A solar system in accordance with claim 9, wherein the mounting surface comprises a corrugated metal rooftop having a plurality of ridges.

13. A solar system in accordance with claim 12, wherein the mount comprises a mounting bracket coupled between the solar module and the corrugated metal rooftop, wherein the mounting bracket is substantially U-shaped.

14. A solar system in accordance with claim 9, wherein the mounting surface comprises a substantially flat concrete rooftop.

15. A solar system in accordance with claim 14, wherein the mount comprises a mounting bracket coupled to the solar module and a mounting block coupled between the mounting bracket and the concrete rooftop, wherein the mounting block is formed from one of steel or lightweight concrete.

16. A method of assembling a solar assembly, the method comprising:
providing a solar module;
attaching a first end of a mount to the solar module;
applying a structural adhesive compound to at least one of a second end of the mount and a mounting surface;
bonding the mount to the mounting surface using the structural adhesive compound.

17. A method in accordance with claim 16, wherein bonding the mount to the mounting surface using the structural adhesive compound comprises bonding the mount to the mounting surface using the structural adhesive compound such that the structural adhesive compound prevents contact between the mount and the mounting surface.

18. A method in accordance with claim 16, wherein applying a structural adhesive compound to a second end of the mount comprises applying the structural adhesive compound to a second end of a mounting block.

19. A method in accordance with claim 16, wherein applying a structural adhesive compound to a second end of the mount comprises applying the structural adhesive compound to a second end of a mounting bracket.

20. A method in accordance with claim 16, wherein applying a structural adhesive compound comprises applying the structural adhesive compound formed from at least one of a polyurethane and a polyether material.
